(19) United States
(12) Patent Application Publication
(10) Pub. No.: US 2010/0086748 A1
(43) Pub. Date: Apr. 8, 2010

(54) Foam Sheets And Method Of Making The Same

(75) Inventor: Hui Li Wang, Tanzih (TW)

Correspondence Address: Wang Law Firm, Inc., 4989 Peachtree Parkway,, Suite 200, Norcross, GA, 30092, US

(73) Assignee: Min Chen Chiang, Tanzih (TW)

(21) Appl. No.: 12/245,716

(22) Filed: Oct. 4, 2008

(51) Int. Cl. B32B 3/26; B32B 3/02

(52) U.S. Cl. 428/192; 264/134

(57) ABSTRACT

A foam sheet and the method of making the same are disclosed. The method is used to manufacture a foam sheet that is cut into several pads to be patched into a mat. The bottom surface of each pad is coated with an adhesive material for adhesion onto the ground. A guiding angle structure is formed around the top surface of the pad by thermal compression and cooling formation. With this structure, the pads can be connected to form a mat.

### BACKGROUND OF THE INVENTION

1. Field of Invention

The invention relates to a foam sheet and the method of making the same. In particular, the invention relates to pads of a foam sheet that adheres to the ground better and the method of making the same.

2. Related Art

As shown in FIG. 8, a conventional mat consists of several pads 90 combined together. Each of the pads 90 is rectangular. Each side of the pad 90 has a saw-like structure 91 for combining with each other. Moreover, the pads 90 may have different colors.

However, the conventional pads 90 are normally obtained by cutting a big sheet. Moreover, the pads 90 are made of a foam material. Therefore, it is soft and deformable. The thickness of each pad 90 usually has a tolerance of about ±0.5 mm. Therefore, they have the following problems:

1. Since the pad 90 is soft, the junctions between the saw-like structures 91 of two pads 90 are likely to sink or depart as people step or walk on them. This produces gaps between the pads 90. Besides, the mat does not completely adhere to the ground. Dusts can fall into the gaps. After a long time, dusts will accumulate between the junction gaps of the pads 90 and between the pads 90 and the ground. As shown in FIG. 9, it is easier to remove dusts on the surfaces of the pads 90 when one uses a vacuum cleaner. But it is difficult to remove the dusts between the pads 90 or between the mat and the ground. In this case, one has to take the pads 90 apart for cleaning.

2. As described above, each side of the pad 90 has a saw-like structure 91. When the pad 90 is dyed with some color, the edges and corners are also given the same color. After the pads 90 are combined, one usually realizes that the saw-like structures have inconsistent colors, forming a pattern of alternating colors. Moreover, when pads 90 of one color are patched together, there is usually some noticeable color difference between the surface and sides of a single pad 90. This is because the heights of the pads 90 are not exactly the same. Such color differences observed due to different heights of the pads, as shown in FIG. 10, are unpleasant and may be more apparent when observing from different angles.

3. The conventional pads 90 are mostly in the shape of rectangles. One has to take into account the problem of junctions between various saw-like structures. Therefore, the shape and combining pattern are very limited.

Consequently, it is imperative to provide a new pad 90 that can solve the above-mentioned problems.

### SUMMARY OF THE INVENTION

An objective of the invention is to provide a foam sheet and the method of manufacturing the same. The bottom surface of the disclosed pad is coated with an adhesive material for it to adhere onto the ground. A guiding angle structure is formed around the top surface of the pad by thermal compression. As a result, the pad can tightly adhere onto the ground. The tight connection between the pads avoids dusts from falling into the gaps in between. There is no such problem as rising saw-like structures between the pads. Moreover, the guiding angle structure of the pad ensures a good visual effect for the pads patched together.

To achieve the above-mentioned objective, the invention includes: an adhesive material coated on the bottom surface of the pad for a tight adherence onto the ground and a guiding angle structure around the top surface of the pad formed by thermal compression.

### BRIEF DESCRIPTION OF THE DRAWINGS

The invention will become more fully understood from the detailed description given herein below illustration only, and thus is not limitative of the present invention, and wherein:

FIG. 1 is a flowchart of the disclosed method;

FIG. 2 is a schematic view of combining the disclosed pads;

FIG. 3 is a schematic view of forming the disclosed guiding angle structure by molding;

FIG. 4 is a schematic view showing the guiding angle structure of the combined pads;

FIG. 5 is an enlarged view of the junction in FIG. 4;

FIG. 6 is a schematic view of observing the color printed on the surface layer of the pads;

FIG. 7 is a schematic view of the disclosed mat according to a second embodiment of the invention;

FIG. 8 is a schematic view of a conventional mat:

FIG. 9 is a schematic view of cleaning pads of the conventional mat; and

FIG. 10 is a schematic view of observing the color printed on the surface layer of the pads.

### DETAILED DESCRIPTION OF THE INVENTION

The present invention will be apparent from the following detailed description, which proceeds with reference to the accompanying drawings, wherein the same references relate to the same elements.

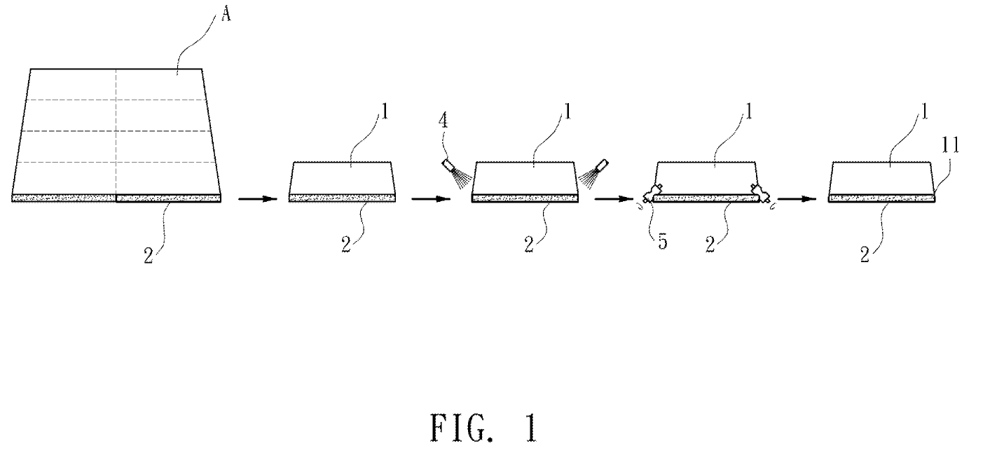

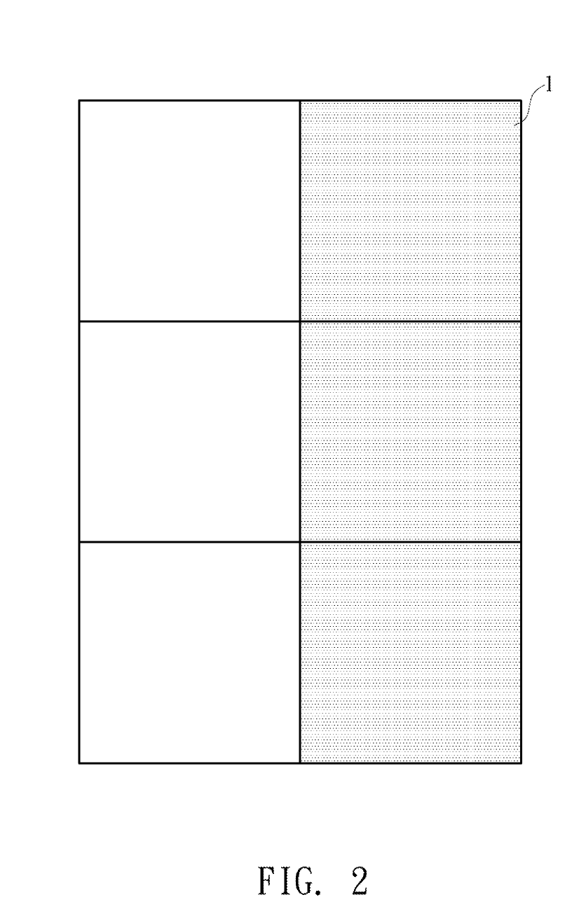

Please refer to FIGS. 1 to 6 for a first embodiment of the invention. It is used for explaining the invention, and should not be used to restrict the scope thereof defined by the claims.

This embodiment demonstrates a method of making a foam sheet. The foam sheet is then cut into several units of pads 1 to form a mat.

The bottom surface of each pad 1 is coated with an adhesive material for a tight adherence to the ground. A guiding angle structure is formed around the top surface of the pad 1 by heating, compressing, and cooling.

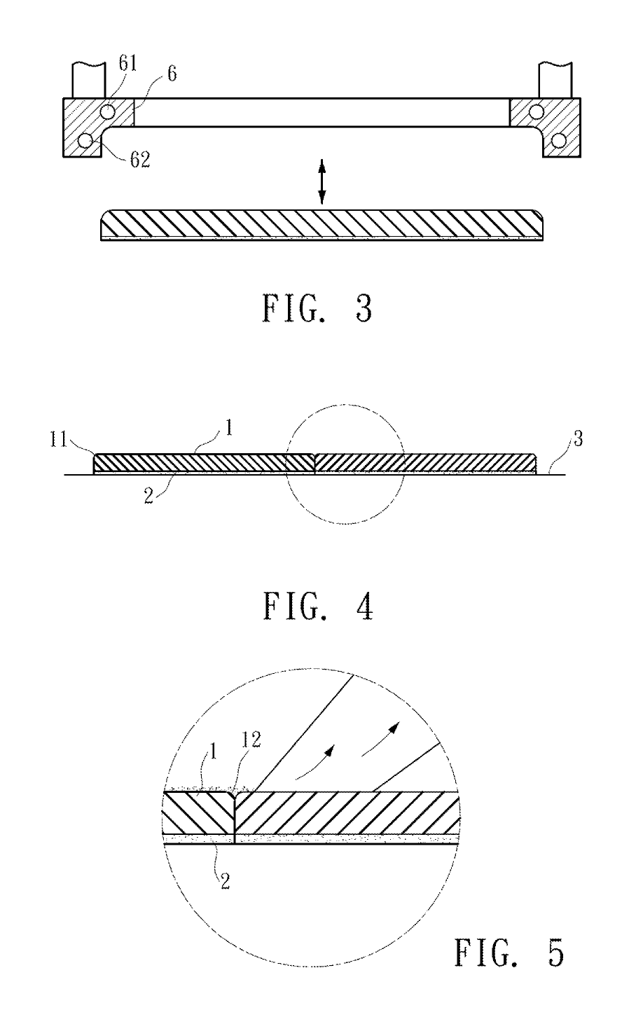

In this embodiment, the pad 1 is made of a foam material, ethylene vinyl acetate (EVA). The rectangular pad 1 is obtained by cutting a big piece of pad material A, after an adhesive is coated on the bottom surface thereof. In this embodiment, the guiding angle structure of the pad 1 is formed by blowing hot air with a hot air device 4 to soften it, followed by pressing with a roller 5. The roller 5 is provided with a cooling pipeline for cooling water to run through (not shown). Therefore, the guiding angle structure is formed after cooling. This process can be replaced by another equivalent process in other embodiments. As shown in FIG. 3, the pad 1 is formed in a mold 6 having the appropriate shape for the guiding angle structure. The mold 6 is provided with a heating pipe 61 and a cooling water circulation pipeline 62. After heating up the mold 6, it is imposed on the top surface of the pad 1. Afterwards, the pad 1 is cooled to form the guiding angle structure.

The foam sheet prepared using the above-mentioned method, as shown in FIG. 4, includes a plurality of pads 1 to be patched together to form a mat. The bottom surface of the pad 1 is coated with an adhesive layer 2 for the pad 1 to adhere firmly onto the ground 3. A guiding angle part 11 is formed around the top surface of the pad 1. In this embodiment, the guiding angle part 11 of the pad 1 is an arc angle.

Since the bottom surface of the pad 1 is coated with an adhesive material (adhesive layer 2) for adhering onto the ground 3 and a guiding angle structure (guiding angle part 11) is formed around the top surface of the pad 1 by thermal compression, the disclosed foam sheet and the method of making the same have the following advantages over the prior art:

1. The pads 1 are firmly adhered to the ground 3 and the pads 1 are tightly connected with each other. This avoids dusts from falling into the gaps and accumulated therein. Because of the guiding angle part 11, dusts may accumulate in the concave junction between the guiding angle parts 11. However, such dusts do not fall between the pads 1 because of their tight connections. It makes cleaning much easier. As shown in FIG. 5, the vacuum cleaner can readily remove the dusts.

2. The conventional pads are mostly in the shape of rectangles. One has to take into account the problem of junctions between various saw-like structures. Therefore, the connection patterns are very limited. Since the disclosed pads 1 are fixed by adhesion, there is no limitation in their patterns. Besides, the guiding angle structure (guiding angle part 11) of the disclosed pad 1 renders a better appearance after the pads are patched together.

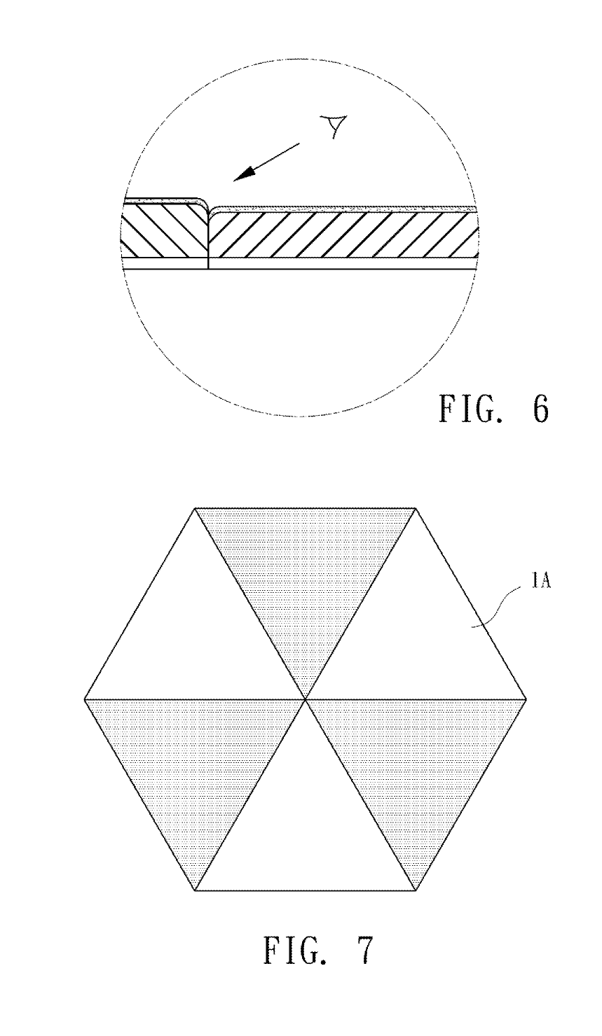

3. The pads are normally printed with a color after their formation. As shown in FIG. 6, the printed color layer extends along the guiding angle structure (guiding angle part 11) at the edges of the pads. If there is a height difference after two pads are patched together, the arc of the guiding angle structure enables the printed color to be continuous. Therefore, there is no noticeable color difference at the junctions.

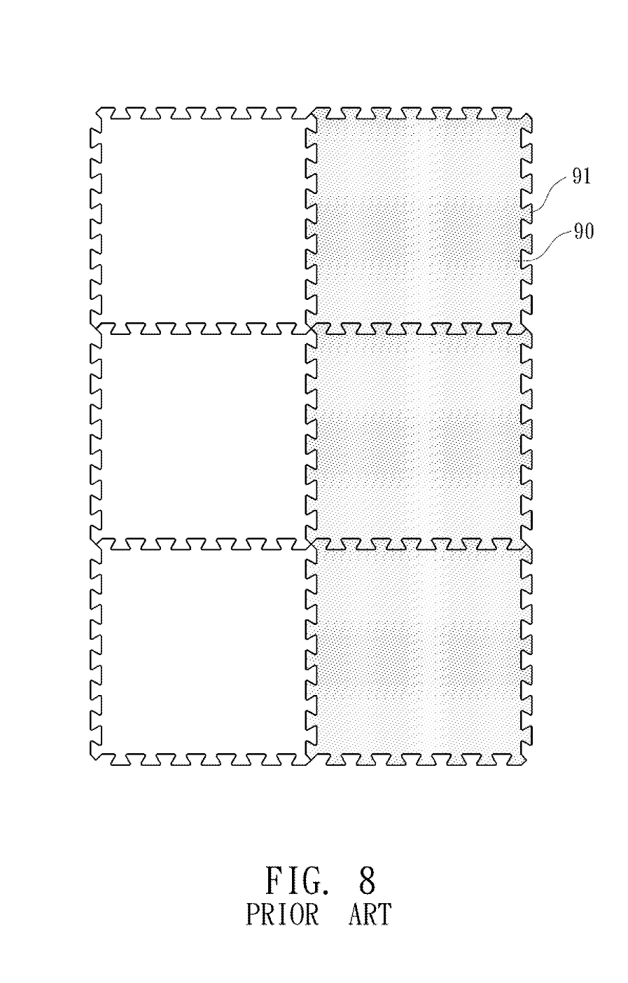

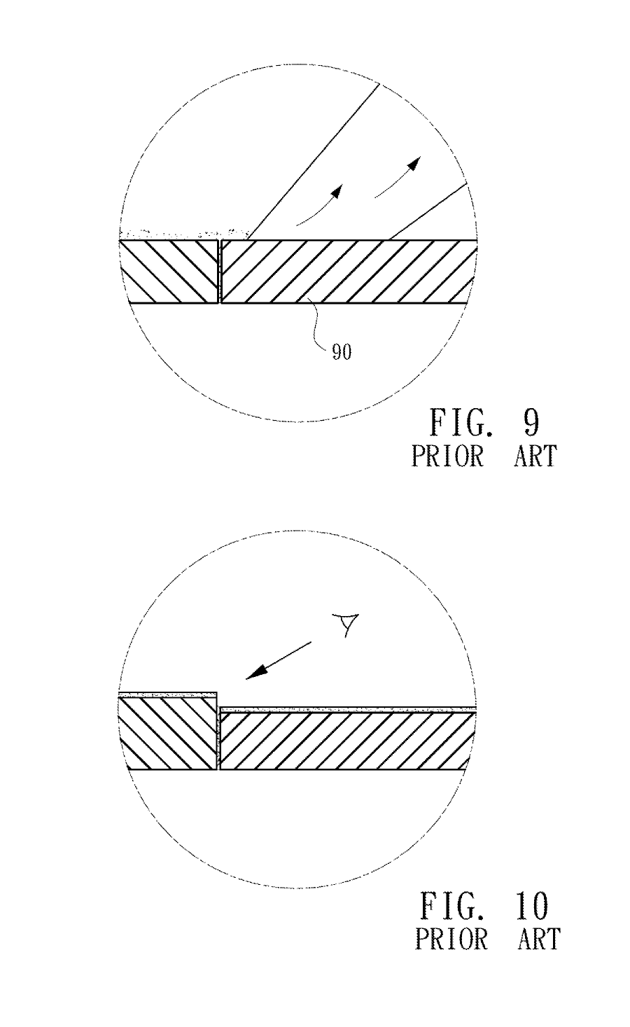

The invention, of course, has many other embodiments with minor variations from the ones introduced herein. Please refer to FIG. 7 for a second embodiment. The pad 1A has a triangular shape. They are patched together to form a hexagonal mat. As described before for the first embodiment, the pads are fixed to the ground by adhesion. There are thus more patching patterns in comparison with the prior art.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method of making a foam sheet to be cut into a plurality of pads that are patched to form a mat, the method comprising the steps of:
coating an adhesive material on the bottom surface of each of the pads for adhesion onto the ground; and
heating, compressing, and cooling around the top surface of the pad to form a guiding angle structure.

2. The method of claim 1, wherein the guiding structure is formed by first heating to soften the pad, followed by compressing and cooling for formation.

3. The method of claim 1, wherein the guiding angle structure is formed from heating, compressing and cooling in a mold having an appropriate shape.

4. A foam sheet formed using the method of claim 1, comprising:
a plurality of pads that are patched to form a mat;
an adhesive layer coated on the bottom surface of the pad for adhesion onto the ground; and
a guiding angle structure around the top surface of the pad.

5. The foam sheet of claim 4, wherein the guiding structure is formed by first heating to soften the pad, followed by compressing and cooling for formation.

6. The foam sheet of claim 4, wherein the guiding angle structure is formed by thermal compression and cooling formation in a mold having an appropriate shape.

7. A foam sheet formed using the method of claim 1, comprising:
a plurality of pads that are patched to form a mat;
an adhesive layer coated on the bottom surface of the pad for adhesion onto the ground; and
a guiding angle structure around the top surface of the pad formed by thermal compression and cooling formation.

8. The foam sheet of claim 7, wherein the guiding angle structure of the pad is an arc angle.
